(19) United States
(12) Patent Application Publication
(10) Pub. No.: US 2020/0063932 A1
(43) Pub. Date: Feb. 27, 2020

(54) REFLECTOR SYSTEM, METHOD FOR MANUFACTURING A REFLECTOR SYSTEM AND LIGHT MODULE COMPRISING SUCH A REFLECTOR SYSTEM

(71) Applicant: Hella GmbH & Co. KGaA, Lippstadt (DE)

(72) Inventors: David Duhme, Lippetal (DE); Werner Kösters, Lippstadt (DE); Michael Lakenbrink, Oelde (DE)

(21) Appl. No.: 16/349,754

(22) PCT Filed: Nov. 6, 2017
(86) PCT No.: PCT/EP2017/078294

§ 371 Date: May 14, 2019

(30) Foreign Application Priority Data
Nov. 16, 2016 (DE) 10 2016 122 013.2

(51) Int. Cl. F21S 41/147; F21S 41/39; F21S 41/37; B29C 45/14; F21S 45/47

(52) U.S. Cl. CPC F21S 41/147; F21S 41/39; B29L 2011/0083; B29C 45/14; F21S 45/47; F21S 41/37

(57) ABSTRACT

A reflector system to form a light module for an illuminating device of a vehicle. The reflector system has a base body and a reflector arranged on the base body. A light module comprises such a reflector system. The base body is made of a metal body and the reflector is made of a thermoplastic material, and the thermoplastic material forming the reflector is injection molded onto the metal body which forms the base body.

### CROSS REFERENCE

This application claims priority to PCT Application No. PCT/EP2017/078294, filed Nov. 6, 2017, which itself claims priority to German Patent Application 10 2016 122013.2, filed Nov. 16, 2016, the entirety of both of which are hereby incorporated by reference.

### FIELD OF THE INVENTION

This invention consists of a reflector system for the purpose of forming a light module for an illuminating device for a motor vehicle which has a base body and a reflector arranged on the base body. In addition, the invention involves a method for manufacturing a reflector system for forming a light module for an illuminating device of a vehicle. Furthermore, the invention involves a light module for an illuminating device of a vehicle.

### BACKGROUND

A corresponding reflector system is known from DE 10 2014 101 784 A1, which has a base body and a reflector. The reflector and the base body are formed from a single-part element consisting of the same material, where both the base body and the reflector consist of a single metal. However, a reflector consisting of metal has only limited dimensional accuracy, which means that the small design dimensions of a reflector system that are consistently in ever-greater demand, and with it, a light module, are technically unfeasible.

### SUMMARY OF THE INVENTION

Therefore, it is the task of this invention to make a reflector system, a method for manufacturing a reflector system, and a light module available in which smaller design dimensions can be attained.

The solution for the task in accordance with the invention can be attained with the features of the independent claims. Preferred designs and embodiments of the invention are specified in the dependent claims.

The reflector system in accordance with the invention is characterized in that the base body is a metal body and the reflector is made of a thermoplastic material, wherein the thermoplastic material that makes up the reflector is injection molded onto the metal body that makes up the base body.

The solution for the task in accordance with the invention is further achieved using a method to manufacture a reflector system to form a light module for an illuminating device of a vehicle in which a base body is formed by a metal body, for example, manufactured in a metal die casting process and a reflector is arranged on the base body by injecting a thermoplastic material that forms the reflector onto the base body.

In a reflector system in accordance with the invention, the base body and the reflector are made up of different materials, wherein the base body is made up of a metal material and the reflector is made up of a plastic material.

In this process, the base body in particular is made from a metal die-cast body, which means the base body is only slightly susceptible to shrinkage during the manufacturing process. There is also the option for the metal body that the base body consists of to be formed from a metal die-cast body, an aluminum die-cast body or a zinc die-cast body and that it contains a magnesium alloy, an aluminum alloy or a zinc alloy. Alternatively, the metal body can also be formed from a metal extruded body or from a shaped sheet metal body.

By creating the base body using a method with low shrinkage, the base body can be manufactured with a high degree of dimensional accuracy. The reflector is formed directly on the base body. To do so, the reflector is injection molded onto the base body in an injection molding process. The reflector is made from a thermoplastic material which can be processed easily in the injection molding process.

As an example, polycarbonate could be used as the thermoplastic material. Because the reflector is injection molded two-dimensionally onto the base body as a thermoplastic material, a particularly smooth layer forming the reflector can be applied to the base body, which allows any unevenness that occurs, particularly when the base body has been manufactured through a die casting process, to be easily compensated for with a high degree of precision. In addition, the thickness of the reflector injection molded onto the base body can be adjusted very precisely by using a thermoplastic material. In comparison to conventional reflectors, the reflector system can be built smaller thanks to the high level of dimensional accuracy that can be achieved by means of the invention, which makes smaller design dimensions achievable in the reflector systems made in accordance with the invention.

In order to be able to further increase the dimensional accuracy of the reflector system, it is preferable that the thermoplastic material that makes up the reflector be injection molded as a thin layer onto the metal body making up the base body. By means of the design as a thin layer, any possible shrinkage of the thermoplastic material when it is injected onto the base body is so low that it has no impact on the dimensional accuracy of the reflector or the reflector system. The thin layer or film used to form the reflector, for example, has a thickness of 0.5 mm to 2 mm, preferably 1 mm to 1.8 mm, and particularly preferably 1.5 mm.

Furthermore, there is the option to passivate the surface of the base body made of metal prior to injecting on the reflector, for example by applying a passivating layer, e.g. using paint. Passivating achieves the benefit that magnesium hydroxide from the metal body including a magnesium alloy is prevented from diffusing into the plastic layer.

The metal body that makes up the base body is preferably made of a magnesium alloy. A magnesium die-cast body has a particularly excellent cooling effect, which allows the reflector arranged on the base body to be effectively cooled so that overheating of the reflector, particularly with small design dimensions, can be reliably prevented. In addition, a die-cast body made of a magnesium alloy is dimensionally more tolerable in terms of evenness than a die-cast body made of other metal alloys, such as an aluminum alloy. This means that, in an arrangement of multiple reflectors on a single base body, a photometric alignment for a cut-off line is possible without any adjustments. In addition, a metal die-cast body made of a magnesium alloy is characterized by a significantly lower weight in comparison to other metal alloys, such as aluminum alloys, so that the entire reflector system can have a particularly low weight, especially when an additional weight reduction can also be achieved through the design of the reflector to be made of a thermoplastic material and not from a metal.

Preferably, a metalization layer is applied to a surface of the reflector. The surface of the reflector, on which the metalization layer is applied, is the surface that is pointed away from the base body. The metalization layer forms an electrically conductive, optically reflecting layer. The metalization layer can be applied to the surface of the reflector without prior painting of the surface of the reflector, which is particularly enabled by the design of the reflector with a thermoplastic material.

It is preferable that the reflector has a depth that is smaller than 25 mm. This low depth makes the reflector especially small in design, so that very small light emissions can be made possible.

Furthermore, the task of the invention is solved using a light module for an illuminating device of a vehicle which has a printed circuit board, at least one semiconductor light source arranged on the printed circuit board, and a reflector system, where the reflector system is designed and developed as described above.

For example, the printed circuit board with the semiconductor light source can be arranged to be in direct contact with the reflector system. The reflector system, and in particular its base body, can in this way serve not only as a carrier for the printed circuit board, but can also be used as a heat sink for electronic components on the printed circuit board and particularly for the semiconductor light source.

The printed circuit board is preferably attached on the reflector of the reflector system, wherein the reflector, when it is injection molded onto the base body, can have mounting device molded onto it which holds the printed circuit board and in which the printed circuit board can be secured. At the same time the reflector is injection molded onto the base body, a mounting device can be created in a process step, wherein the mounting device is then made out of the same material as the reflector. The mounting device allows a quick and simple mounting of the printed circuit board to the reflector without requiring additional resources to secure it. This means the light module manufacturing process can be simplified and also means that it takes less time to manufacture it.

The mounting device can be designed such that it is made as a type of guide rail in which the printed circuit board can be inserted. Other shapes and embodiments of the mounting device are also possible, where the design of the mounting device can be very flexibly be adjusted when the reflector is injection molded onto the base body and, therefore, the shape of the mounting device can very flexibly be adjusted during an injection molding process. The base body of the reflector system can

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a schematic drawing of a top view of a light module with a reflector system according to the invention.

FIG. 2 shows a schematic cross-section of the light module shown in FIG. 1 along the line A-A.

FIG. 3 shows a schematic drawing of a flowchart for manufacturing a reflector system shown in FIGS. 1 and 2.

### DETAILED DESCRIPTION OF THE DRAWINGS

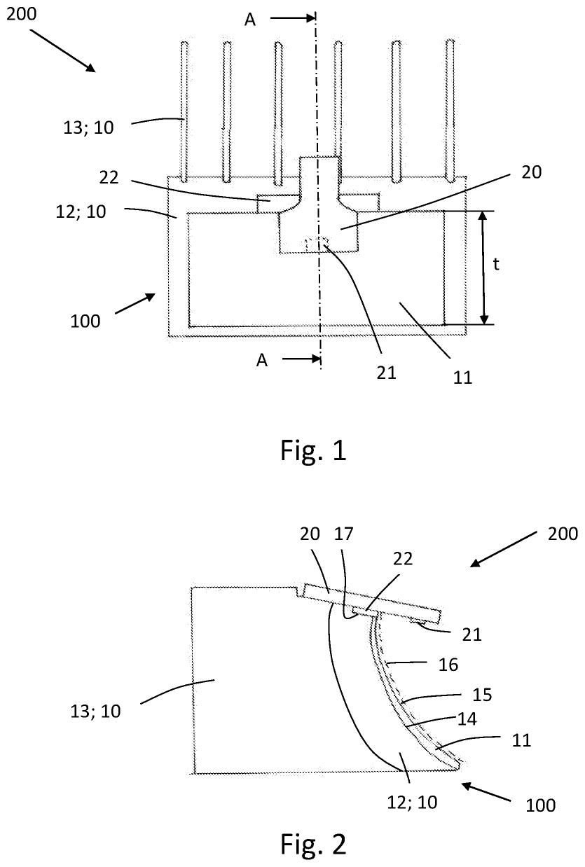

FIGS. 1 and 2 show a light module 200 with a reflector system 100 in accordance with the invention for an illuminating device for a motor vehicle, whereas FIG. 2 shows a cross-section along the line A-A from FIG. 1.

The reflector system 100 has a base body 10 and a reflector 11 arranged on the base body 10. The base body 10 is shown in the design shown here designed as a heat sink, and has a block-like basic body 12 with multiple cooling fins 13 parallel to one another arranged on it.

The base body 10 is made of a metal body, particularly of a metal die-cast body. In the design shown here, the preference is for the metal die-cast body to be made of a magnesium alloy.

The base body 10 has a curved outer surface 14 on its basic body 12 upon which the reflector 11 is arranged. The reflector 11 is made of a thermoplastic material and is injection molded onto the reflector 11 and on the curved outer surface 14 of the base body 10 or the basic body 12. In the process, the reflector 11 is applied in a thin, flat layer on the base body 10 in an injection molding process so that the reflector 11 is injection molded onto the base body 10 as a thin layer. In the process, the reflector 11 has a depth d which is smaller than 25 mm.

A metalization layer 16 is applied to a surface 15 of the reflector 11 pointing away from the base body 10, which is shown here as a dashed line. The metalization layer 16 forms an optically reflecting layer.

A printed circuit board 20 with a semiconductor light source 21 arranged on it is arranged on the reflector system 100, where the reflector system 100, together with the printed circuit board 20 and the semiconductor light source 21 form the light module 200.

The printed circuit board 20 is secured in a mounting device 22 in that the printed circuit board 20 is inserted into the mounting device 22. The mounting device 22 can be molded for this in such a way that it is a type of guide rail. As can be seen in FIGS. 1 and 2, the mounting device 22 projects beyond the reflector 11 so that the mounting device 22 extends along an upper side 17 of the base body 10 at least in certain areas.

The mounting device 22 is made of the same material as the reflector 11, and can be formed at the same time the reflector 11 is injection molded onto the base body 10.

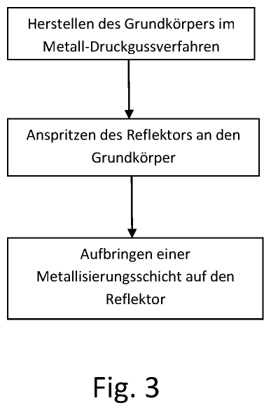

FIG. 3 shows a flowchart of the design of a reflector system 100 such as that shown in FIGS. 1 and 2.

In the process, the base body 10 is first manufactured in a die casting process. Then, the reflector 11 and the mounting device 22 are injection molded onto the base body 10 in the injection molding process. Afterwards, the metalization layer 16 can be applied directly on the surface 15 of the reflector 11 without a previous painting process. Furthermore, there is the option to passivate the surface of the base body 10 prior to injecting the reflector 11, for example by applying a passivating layer, for example using paint. Passivating achieves the benefit that magnesium hydroxide from the metal body including a magnesium alloy is prevented from diffusing into the plastic layer.

The design of the invention is not limited to the preferred embodiment specified here. Rather, a number of variants are conceivable, which make use of the present solution even in designs of a fundamentally different type. All of the features and/or advantages arising from the claims, description or drawings, including design details, physical layout and process steps, may be vital to the invention both by themselves and in a wide variety of combinations.

### REFERENCE NUMERAL LIST

200 Light module
100 Reflector system
10 Base body
11 Reflector
12 Basic body
13 Cooling fins
14 Outer surface
15 Surface
16 Metalization layer
17 Upper side
20 Printed circuit board
21 Semiconductor light source
22 Mounting device
d depth

1. A reflector system to form a light module for an illuminating device of a vehicle, the reflector system comprising:
a base body made of a metal body; and
a reflector made of a thermoplastic material and arranged on the base body,
wherein the thermoplastic material that makes up the reflector is injection molded onto the metal body that makes up the base body.

2. The reflector system according to claim 1, wherein the thermoplastic material that makes up the reflector is injection molded as a thin layer onto the metal body that makes up the base body.

3. The reflector system according to claim 1 wherein the metal body that makes up the base body is formed:
by means of a metal die-cast body, an aluminum die-cast body, or a zinc die-cast body and has a magnesium alloy, an aluminum alloy or a zinc alloy, or is made up of a metal extruded body or from a sheet metal body.

4. The reflector system according to claim 1, wherein a metalization layer is applied to one surface of the reflector.

5. The reflector system according to claim 1, wherein the reflector has a depth (d) which is smaller than 300 mm.

6. A method for manufacturing a reflector system to form a light module for an illuminating device of a vehicle, the method comprising the steps of:
forming a base body made from a metal body;
forming a reflector from a thermoplastic material on the base body,
wherein the thermoplastic material that makes up the reflector is injection molded onto the base body made of metal.

7. The method according to claim 6, wherein a magnesium alloy is used to form the base body.

8. The method according to claim 5, wherein a metalization layer is applied to one surface of the reflector.

9. The reflector system of claim 1, further comprising:
a printed circuit board, and
at least one semiconductor light source arranged on the printed circuit board, and
the reflector system, printed circuit board and reflector system forming a light module for a vehicle.

10. The reflector system of claim 9, wherein the printed circuit board is attached to the reflector of the reflector system, where the reflector has a mounting device in which the printed circuit board is secured that is created when injecting the reflector onto the base body.
